(19) United States
(12) Patent Application Publication
(10) Pub. No.: US 2019/0388743 A1
(43) Pub. Date: Dec. 26, 2019

(54) Composite Golf Club Head and Method of Manufacturing the Same

(71) Applicant: O-Ta Precision Casting Co., Ltd., Pingtung Hsien (TW)

(72) Inventors: Yen Chi Hsu, Pingtung Hsien (TW); Chi Wen Ling, Pingtung Hsien (TW)

(21) Appl. No.: 16/442,759

(22) Filed: Jun. 17, 2019

(30) Foreign Application Priority Data
Jun. 21, 2018 (TW) 107121293
Jun. 21, 2018 (TW) 107208315
Dec. 21, 2018 (TW) 107146437

(51) Int. Cl. A63B 53/04; B29C 70/34; B29C 70/54

(52) U.S. Cl. CPC A63B 53/04; B29C 70/342; B29C 70/54; B29K 2307/04; A63B 53/047; A63B 2209/02; A63B 2053/042; A63B 53/0466

(57) ABSTRACT

A composite golf club head has a head body and a striking plate. The head body has a main portion and a hosel. The main portion is made of carbon fiber composite material and is integrally formed as a single part. The hosel is formed on a front end of the main portion. The striking plate is mounted on the head body. A method of manufacture the composite golf club head comprises steps of putting a plurality of carbon fiber composite prepregs that are piled up and the striking plate into a mold assembly, closing the mold assembly to form a blank of a golf club head, using a pressure forming device to create vacuum inside the mold assembly and to heat the mold assembly to get a semi-finished if golf club head, and deburring to form the composite golf club head.

### CROSS-REFERENCE TO RELATED APPLICATIONS

This application is based upon and claims priorities under 35 U.S.C. 119 from Taiwan Patent Application No. 107121293 filed on Jun. 21, 2018, Taiwan Patent Application No. 107146437 filed on Dec. 21, 2018, and Taiwan Patent Application No. 107208315 filed on Jun. 21, 2018, which are hereby specifically incorporated herein by this reference thereto.

### BACKGROUND OF THE INVENTION

### 1. Field of the Invention

The present invention relates to a golf club head, and more particularly to a golf club head made of a composite material and a method of manufacturing the golf club head.

### 2. Description of Related Art

A center of gravity and inertia of a golf club head are important factors in designing the golf club head, so as to allow a golf ball to fly long distance stably along a specific direction when a golf club is swung to hit the golf ball. In order to improve the freedom in designing the center of gravity and the inertia of the golf club head, golf related manufacturers have proposed to use carbon fiber composite materials to manufacture part of or all of the golf club head.

Taiwan Patent No. I307285 discloses a golf club head made of a carbon fiber composite material. The golf club head has a striking plate, a crown, a sole plate, and a counterweight. The striking plate is made of metallic material. The crown and the sole plate are made of carbon fiber composite material. The counterweight is adhered to the sole plate and made of a metallic material having a high specific gravity. The crown and the sole plate are adhered together via a film adhesive to form a head body. The striking plate is adhered to a front side of the head body via the film adhesive to form the golf club head for a wood-type golf club.

The aforementioned golf club head is formed by the crown and the sole plate that are made of a carbon fiber composite material, so as to increase the flying distance of the golf ball when hitting the golf ball. However, the bonding strength formed by the film adhesive is not strong enough to allow the striking plate to be firmly adhered to the front side of the head body, or the crown and the sole plate to be firmly adhered together. Moreover, the striking plate, the crown, the sole plate, and the counterweight of the golf club head are individually formed parts, and then are adhered together by the film adhesive. Therefore, the golf club head has problems of high manufacturing cost and long manufacturing time.

In addition, for the manufacturer of the golf club, it is necessary to measure the center of the striking plate of the golf club head based on the international standards. As for the physical characteristics of the golf club head, the position of the sweet point is not necessarily located at the geometric center point of the striking plate, particularly for the golf club head with the striking plate made of metallic materials and the head body made of carbon fiber composite materials. Since the metallic material is heavier than the carbon fiber composite material, the sweet point is not necessarily located at the geometric center point of the striking plate. It means the sweet point may be located around the geometric center point. It is difficult to grasp the sweet point when the user is playing the golf. Therefore, the manufacturer of the golf club changes the position of the counterweight to allow the sweet point to be located at the geometric center point of the striking plate. However, controlling the position of the sweet point by &hanging the position of the counterweight is hard to accomplish.

Taiwan Patent No. I397437 discloses that a golf club head with additional discretionary mass is realized by utilizing lightweight materials, a favorable average crown height, or multiple hinge points on the crown. By using a preferred break length, the additional discretionary mass may be placed low and deep in the golf club head to change the position of the center of gravity and inertia. The center of gravity of the golf club head can be positioned to substantially align with the sweet point and the geometric center point of a striking plate of the golf club head.

Although the aforementioned golf club head with additional discretionary mass can indeed achieve the purpose of changing the position of the center of gravity and inertia to position the center of gravity of the golf club head to substantially align with the sweet point and the geometric center point, it is difficult to distribute the weight of the golf club head and to set other parameters since the golf club head is made of the metallic material and has a lightweight connecting member made of heterogeneous collection. Since a lot of simulation tests have to be performed, it is difficult to manufacture the golf club head.

To overcome the shortcomings, the present invention tends to provide a composite golf club head and a method of manufacturing the composite golf club head to obviate the aforementioned problems.

### SUMMARY OF THE INVENTION

The main objective of the invention is to provide a composite golf club head and a method of manufacturing the composite club head.

The method of manufacturing a composite golf club head is performed by a mold assembly and a pressure forming device which comprises an openable closed container, a pneumatic component mounted on the openable closed container, and a heating component mounted on the openable closed container, and the method comprises steps of:

providing a striking plate made from a material selected from the group consisting of a carbon fiber composite and a metallic material, wherein the striking plate has a combination portion formed as a back side of the striking plate;

putting a plurality of carbon fiber composite prepregs that are piled up and the striking plate into the mold assembly and closing the mold assembly to form a blank of a golf club head, wherein the carbon fiber composite prepregs are piled up to form a blank of a head body of the golf club head which has a main portion and a hosel, and a front end of the blank of the head body of the golf club head engages with the combination portion of the striking plate to form the blank of the golf club head;

applying vacuum to the mold assembly and heating the mold assembly with the blank of the golf club head inside by using the pressure forming device, wherein the mold assembly with the blank of the golf club head inside is put in a bag and the bag is put into the openable closed container for the pneumatic assembly to create the vacuum in the operable closed container and for the heating assembly to heat the blank of the golf club head, such that the carbon fiber composite prepregs of the blank of the golf club head are hardened by a cross-linking reaction to form a semi-finished golf club head; and

debarring the semi-finished golf club head and finishing a surface of the semi-finished golf club head to form the composite golf club head.

The composite golf club head which is manufactured by the method of manufacturing the composite golf club head comprises a head body and a striking plate. The head body has a main portion and a hosel. The main portion is made of a carbon fiber composite material and is integrally formed as a single part. The hosel is formed on a front end of the main portion. The striking plate is mounted on the head body and made of a material selected from the group consisting of a carbon fiber composite and a metallic material. The striking plate is attached to the front end of the main portion and has a combination portion and a geometric center point. The combination portion is formed as a back side of the striking plate and attached to the main portion. An imaginary line passing through the geometric center point and a center of gravity of the composite golf club head is perpendicular to a tangent plane of the geometric center point.

In the previously disclosed method of manufacturing the composite golf club head, the openable closed container is used to apply the vacuum in the mold assembly to heat the mold assembly with the blank of the golf club head inside. The head body can have uniform quality. In addition, the composite golf club head has excellent structural stability since the hosel and the main portion are integrally formed as a single part.

In the step of applying vacuum to the mold assembly and heating the mold assembly having the blank of the golf club head inside by using the pressure forming device, a pressure value and the heating temperature may also be set according to the conditions required for the cross-linking reaction in the carbon fiber composite prepregs. By setting the pressure value and the heating temperature at different time points through the program control, excess resin in the carbon fiber composite prepregs can be extruded from the carbon fibers, and the bubbles remaining in the carbon fiber composite prepregs can be taken out. Thus, under pressure and heating, the carbon fiber composite prepregs can form a highly compact and dense solid carbon fiber composite. The present invention has the economic benefits of reducing manufacturing cost and manufacturing time.

Furthermore, in the composite golf club head of the present invention, the head body is only made of the carbon fiber composite material. By adopting a single material, it is easier to control a shape and a weight of the composite golf club head. Moreover, it is also easier to allow the imaginary line that passes through the geometric center point of the striking plate and the center of gravity of the composite golf club head to be perpendicular to the tangent plane of the geometric center point of the striking plate.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of a first embodiment of a method of manufacturing a composite golf club head in accordance with the present invention;

FIG. 2 is a perspective view of the composite golf club head manufactured by the method in FIG. 1, wherein a wood-type golf club head is presented;

FIG. 3 is an exploded rear perspective view of the composite golf club head in FIG. 2;

FIG. 4 is a top view of the composite golf club head in FIG. 2, showing a geometric center point and a center of gravity;

FIG. 5 is an end view of the composite golf club head in FIG. 2, showing a sweet point located at the geometric center point;

FIG. 6 is a flow chart of a second embodiment of a method of manufacturing a composite golf club head in accordance with the present invention;

FIG. 7 is an exploded perspective view of the composite golf club head manufactured by the method in FIG. 6, wherein a wood-type golf club head is presented;

FIG. 8 is a flow chart of a third embodiment of a method of manufacturing a composite golf club head in accordance with the present invention; and

FIG. 9 is an exploded perspective view of the composite golf club head manufactured by the method in FIG. 8, wherein a wood-type golf club head is presented.

### DETAILED DESCRIPTION OF PREFERRED EMBODIMENT

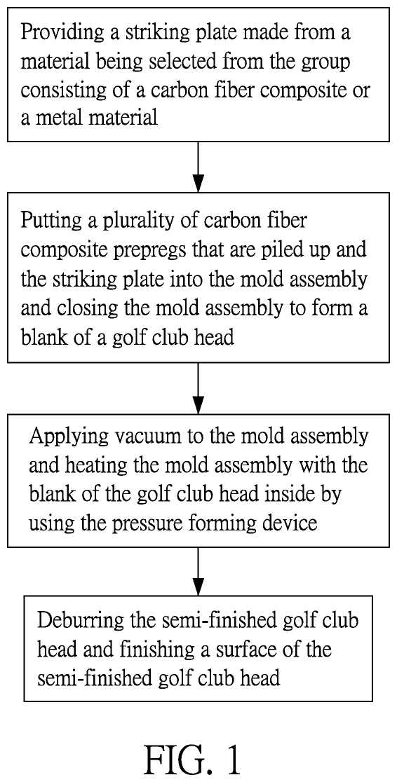

With reference to FIG. 1, a first embodiment of a method of manufacturing a composite golf club head in accordance with the present invention is at least suitable for manufacturing a wood-type golf club head or an iron-type golf club head. The method of manufacturing the composite golf club head is performed by a mold assembly and a pressure forming device. The mold assembly can be closed and disassembled. The pressure forming device comprises an openable closed container, a pneumatic assembly mounted on the openable closed container, and a heating component mounted on the openable closed container. The method comprises steps of:

providing a striking plate made from a material selected from the group consisting of a carbon fiber composite and a metallic material, wherein the is striking plate has a combination portion formed as a back side of the striking plate;

putting a plurality of carbon fiber composite prepregs that are piled up and the striking plate into the mold assembly and closing the mold assembly to form a blank of a golf club head, wherein the carbon fiber composite prepregs are piled up to form a blank of a head body of a golf club head which has a main portion and a hosel, and a front end of the blank of the head body of the golf club head engages with the combination portion of the striking plate to form the blank of the golf club head;

applying vacuum to the mold assembly and heating the mold assembly with the blank of the golf club head inside by using the pressure forming device, wherein the mold assembly with the blank of the golf club head inside is put in a bag and the bag is put into the operable closed container for the pneumatic assembly to create the vacuum in the operable closed container and for the heating assembly to heat the blank of the golf club head, such that the carbon fiber composite prepregs of the blank of the golf club head is hardened by a cross-linking reaction to form a semi-finished golf club head; and

deburring the semi-finished golf club head and finishing a surface of the semi-finished golf club head to form the composite golf club head.

In the step of putting the carbon fiber composite prepregs that are piled up and the striking plate into the mold assembly and closing the mold assembly to form the blank of the golf club head, the blank of the head body of the golf club head with the hosel may be integrally formed as a single part with the carbon fiber composite prepregs directly in the mold assembly. Alternatively, the hosel may be pre-formed along with the carbon fiber composite prepregs and then put into the mold assembly to be combined with the carbon fiber composite prepregs for forming the blank of the head body of the golf club head with the hosel, so as to form the blank of the golf club head.

In the step of putting the carbon fiber composite prepregs that are piled up and the striking plate into the mold assembly and closing the mold assembly to form the blank of the golf club head, a replaceable rod or an angle adjustable rod may be inserted in the hosel. In addition, a metal counterweight may he put in the blank of the golf club head. Specifically, the metal counterweight may be attached to or wrapped by the carbon fiber composite prepregs.

In the step of applying vacuum to the mold assembly and heating the mold assembly with the blank of the golf club head inside by using the pressure forming device, a heating temperature ranges from 40° C. to 250° C., vacuum pressure value ranges from −0.1 mbar to −1000 mbar, and the heating and the vacuuming lasts for 1 minute to 60 minutes. When an autoclave is used as the pressure forming device, the autoclave is able to heat, vacuum, and input positive air pressure to the blank of the golf club head. An air pressure value of the positive air pressure ranges from 2 bar to 100 bar. The vacuum pressure value, the positive air pressure value, and the heating temperature may be set according to conditions such as a shape of the wood-type golf club head and a thickness of the carbon fiber composite prepregs. The vacuum pressure value, the positive air pressure value, and the heating temperature may also be set according to conditions required for the cross-linking reaction in the carbon fiber composite prepregs. By setting the vacuum pressure value, the positive air pressure value, and the heating temperature at different time points through program control, excess resin in the carbon fiber composite prepregs can be extruded from carbon fibers, and bubbles remaining in the carbon fiber composite prepregs can be removed. Thus, under pressure and heating, the carbon fiber composite prepregs can form a highly compact and dense solid carbon fiber composite.

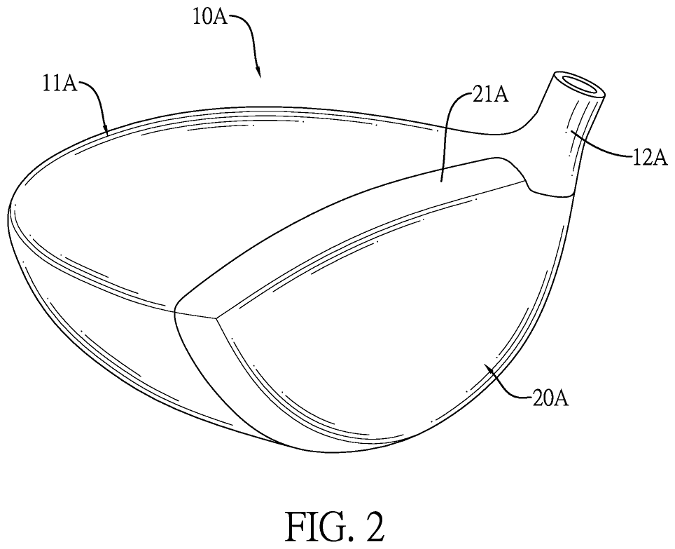

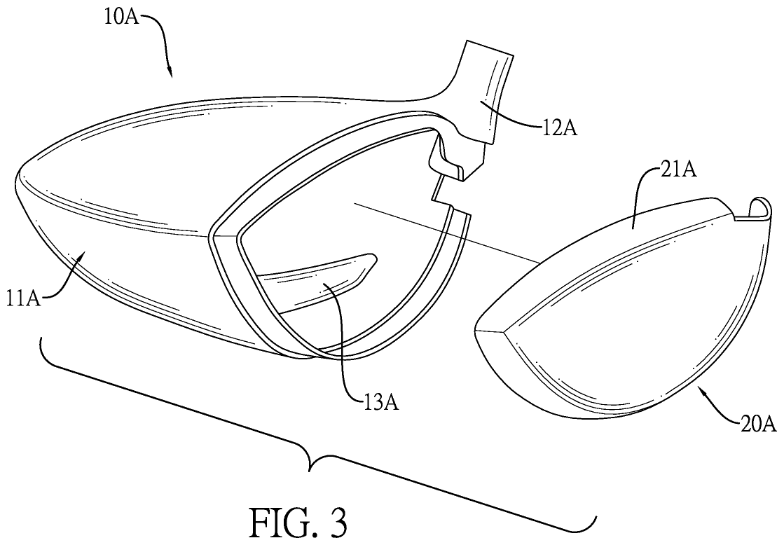

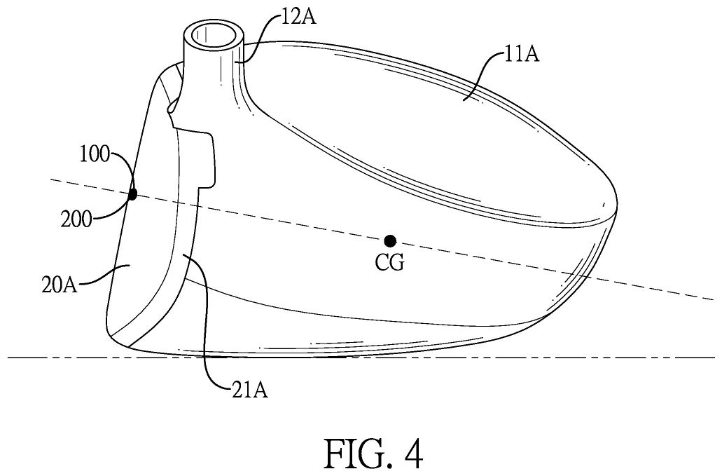

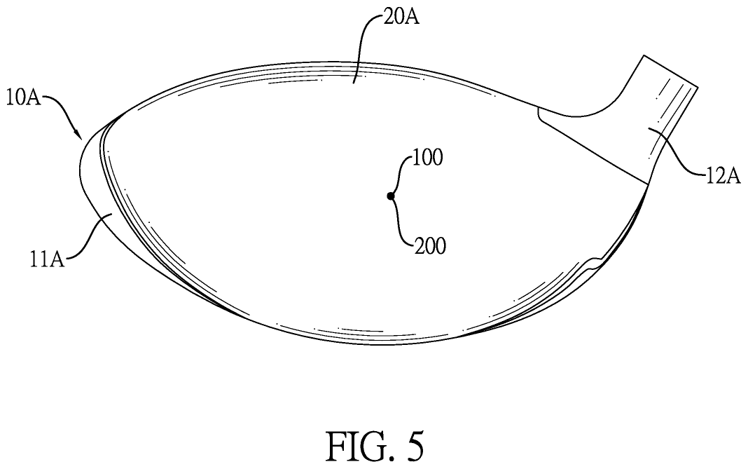

With reference to FIGS. 2 to 5, the composite golf club head which is manufactured by the method as described may be the wood-type golf club head or the iron-type golf club head. The composite golf club head comprises a head body 10A and a striking plate 20A. The head body 10A has a main portion 11A and a hosel 12A. The main portion 11A is made of a carbon fiber composite and is integrally formed as a single part. The hosel 12A is formed on a front end of the main portion 11A. The striking plate 20A is mounted on the head body 10A and made of a material selected from the group consisting of a carbon fiber composite and a metallic material, wherein the metallic material may be titanium alloy or stainless steel. The striking plate 20A is attached to the front end of the main portion 11A and has a combination portion 21A, which is formed as a back side of the striking plate 20A, and is attached to the main portion 11A. The striking plate 20A has a geometric center point 200. An imaginary line passing through the geometric center point 200 and a center of gravity CG of the composite golf club head is perpendicular to a tangent plane of the geometric center point 200. An imaginary line passing through the center of gravity CG and the strike plate 20A and being perpendicular to the strike plate 20A forms a sweet point on the strike plate 20A. Accordingly, a plurality of sweet points may be formed on the strike plate 20A. Preferably, the geometric center point 200 of the striking plate 20A overlaps one of the sweet points of the striking plate 20A.

In the following description, a wood-type composite golf club head is taken as an example. With reference to FIGS. 2 to 5, a first preferred embodiment of the composite golf club head comprises a head body 10A and a striking plate 20A.

With reference to FIGS. 2 to 5, the head body 10A is integrally formed as a single part and is made of the carbon fiber composite. The head body 10A has a main portion 11A and a hosel 12A. The main portion 11A is hollow and has an opening facing frontward. The hosel 12A is formed on a front end of the main portion 11A so that the head body 10A made of the carbon fiber composite is lightweight.

With reference to FIGS. 2 to 5, the striking plate 20A may be made of a material selected from the group consisting of a carbon fiber composite and a metallic material that is the same as the head body 10A. The striking plate 20A has a geometric center point 200 and a combination portion 21A formed as a back side of the striking plate 20A and attached to the main portion 11A. The composite golf club head has a center of gravity CG while the striking plate 20A has a sweet point. An imaginary line passing through the sweet point and the center of the gravity is perpendicular to a tangent plane of the sweet point. Preferably,the sweet point overlaps a geometric center point 200 of the strike plate 20A.

The head body 10A further has at least one metal counterweight which is fixed to a position such as a bottom of the main portion 11A, so as to lower down the center of gravity CG of the composite golf club head. The metal counterweight may be a block made of a tungsten metallic material or other materials having a specific gravity greater than a specific gravity of the iron-based metallic material. The metal counterweight may be attached to an inner side of the head body 10A formed by the carbon fiber composite material, or the metal counterweight may be wrapped by the carbon fiber composite prepregs of the head body 10A, so as to al low the metal counterweight to be firmly fixed in the head body 10A. Alternatively, the metal counterweight may be screwed to the head body 10A. In addition, a replaceable rod may be further inserted inside the hosel 12A. The replaceable rod may be a strength reinforcing member, an angle adjustable sleeve, or a length adjustable sleeve.

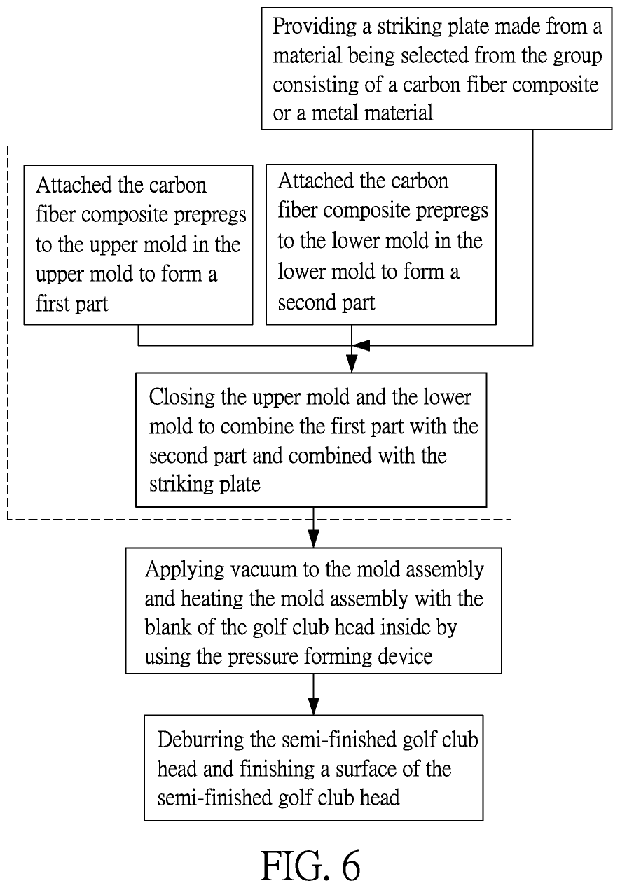

With reference to FIG. 6, a second embodiment of a method of manufacturing a composite golf club head in accordance with the present invention is shown. Steps of the second embodiment and the first embodiment of the methods of manufacturing the composite golf club head are substantially the same. The second embodiment of the method differs from the first embodiment of the method in that the mold assembly comprises an upper mold and a lower mold that are capable of being closed and disassembled. The carbon fiber composite prepregs are attached to the upper mold inside the upper mold to form a first part. The carbon fiber composite prepregs are attached to the lower mold inside the lower mold to form a second part. Then the upper mold and the lower mold are closed to combine the first part with the second part to form a blank of a head body of the golf club head. The blank of the head body of the golf club head is capable of being combined with the striking plate which has been pre-formed.

Then vacuum is applied to the mold assembly and the mold assembly is heated by using the pressure forming device. The mold assembly with the blank of the head body of the golf club head and the striking plate inside is put in a bag and the bag is put into the openable closed container for the pneumatic assembly to create the vacuum and for the heating assembly to heat the blank of the golf club head to form a semi-finished golf club head by the cross-linking reaction in the carbon fiber composite prepregs. Then the semi-finished golf club head is debarred and a surface of the semi-finished golf club head is finished to form the composite golf club head.

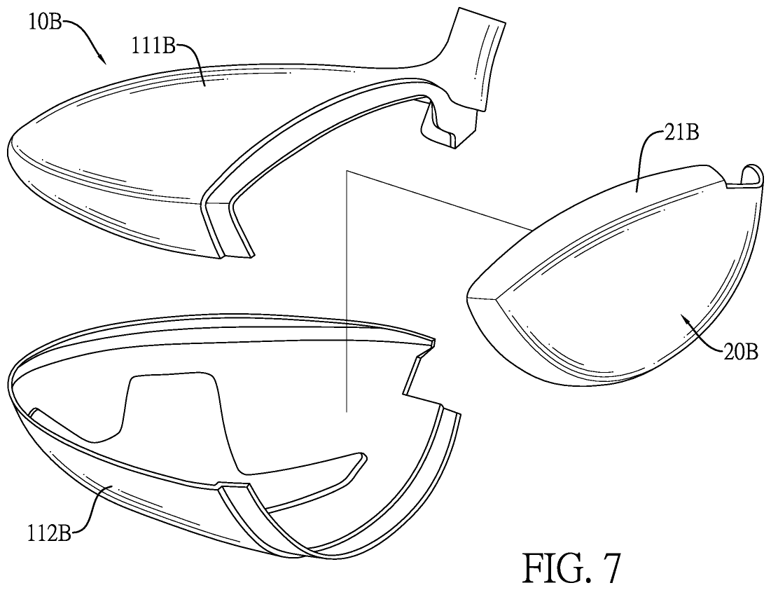

With reference to FIG. 7, the composite golf club head manufactured by the second embodiment of the method as described has the head body 10B made of the carbon fiber composite and the striking plate 2013 mounted on the head body 10B. The striking plate 20B is made of the metallic material.

In the composite golf club head manufactured by the first embodiment of the method, the head body 10A is integrally formed as a single part. With reference to FIG. 7, the head body 10B manufactured by the second embodiment of the method has the first part 111B and the second part 112B. The first part 111B is combined with the second part 1128 to form the head body 1013 that is lightweight.

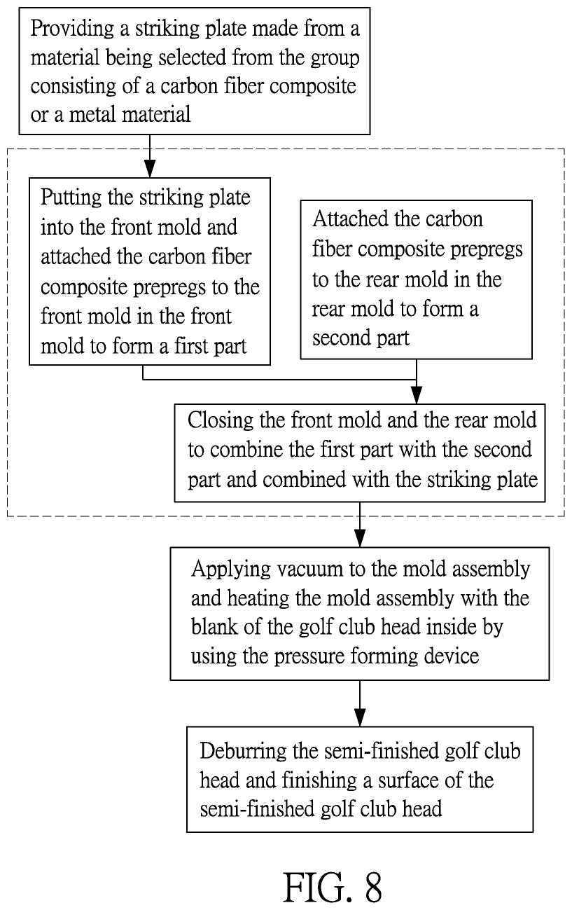

With reference to FIG. 8, a third embodiment of a method of manufacturing a composite golf club head in accordance with the present invention is shown. Steps of the third embodiment and the first embodiment of the methods of manufacturing the composite golf club head are substantially the same. The third embodiment of the method differs from the first embodiment of the method in that the mold assembly comprises a front mold and a rear mold that are capable of being closed and disassembled. The carbon fiber composite prepregs are attached to the front mold inside the front mold to form a first part. The carbon fiber composite prepregs are attached to the rear mold inside the rear mold to form a second part. Then the front mold and the rear mold are closed to combine the first part with the second part to form a blank of a head body of the golf club head. The blank of the head body of the golf club head is capable of being combined with the striking plate which has been pre-formed.

Then vacuum is applied to the mold assembly and the mold assembly is heated by using the pressure forming device. The mold assembly with the blank of the head body of the golf club head and the striking plate inside is put in a bag and the bag is put into the operable closed container for the pneumatic assembly to create the vacuum and for the heating assembly to heat the blank of the golf club head to form a semi-finished golf club head by the cross-linking reaction in the carbon fiber composite prepregs. Then the semi-finished golf club head is deburred and a surface of the semi-finished golf club head is finished to form the composite golf club head.

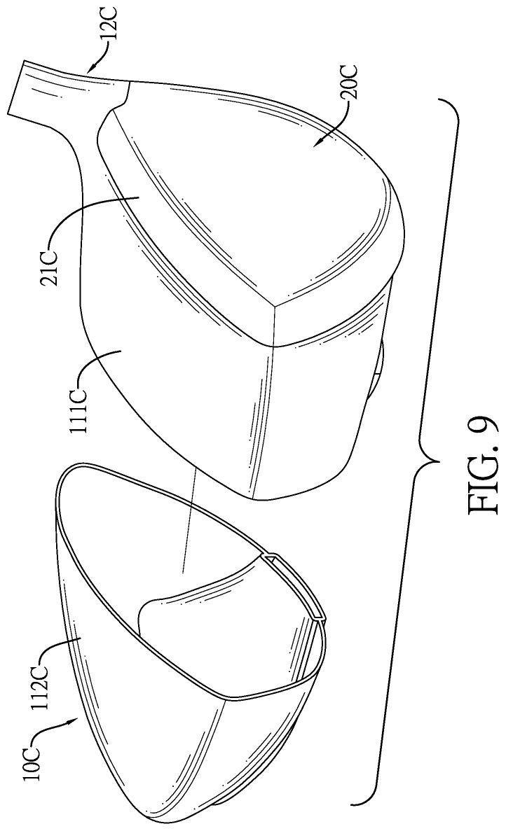

With reference to FIG. 9, the composite golf club head manufactured by the third embodiment of the method as described has the head body 10C made of the carbon fiber composite and the striking plate 20C mounted on the head body 10C. The striking plate 20C is made of the metallic material.

In the composite golf club head manufactured by the first embodiment of the method, the head body 10A is integrally formed as a single part. With reference to FIG. 9, the head body 10C manufactured by the third embodiment of the method has the first part 111C and the second part 112C. The first part 111C is combined with the second part 112C to form the head body 10C that is lightweight.

In the above disclosed composite golf club head and the methods of manufacturing the composite golf club head, the openable closed container is used to apply the vacuum pressure to and to heat the mold assembly with the head body 10A. When the head body 10A is being heated, the head body 10A is solidified by the cross-linking reaction through a hot isostatic pressing process. The head body 10A can have a uniform quality. In addition, the composite golf club head has excellent structural stability since the hosel 12A and the main portion 11A are integrally formed as a single part, i.e. the head body 10A, and the combination portion 21A of the striking plate 20A is securely attached to the front end of the main portion 11A when forming the head body 10A in the mold assembly.

In the step of creating the vacuum in the mold assembly and heating the mold assembly having the head body 10A by using the pressure forming device, the pressure value and the vacuum temperature value may be set according to the conditions required for the cross-linking reaction in the carbon fiber composite prepregs. By setting the pressure value and the heating temperature at different time points by the program control, the excess resin in the carbon fiber composite prepregs can be extruded from the carbon fibers, and the bubbles remaining in the carbon fiber composite prepregs can be removed. Thus, under pressure and heating, the carbon fiber composite prepregs can form a highly compact and dense solid carbon fiber composite. The present invention has the economic benefits of reducing manufacturing cost and time.

Furthermore, in the composite golf club head of the present invention, the head body 10A is only made of the carbon fiber composite material. By adopting a single material, it is easier to control a shape and a weight of the composite golf club head. Moreover, it is also easier to allow the imaginary line that passes through the geometric center point 200 of the striking plate 20A and the center of gravity CG of the composite golf club head to be perpendicular to the tangent plane of the geometric center point 200 of the striking plate 20A.

What is claimed is:

1. A method of manufacturing a composite golf club head, performed by a mold assembly and a pressure forming device which comprises an openable closed container, a pneumatic assembly mounted on the openable closed container, and a heating component mounted on the openable closed container, and the method comprising steps of:
providing a striking plate made from a material being selected from the group consisting of a carbon fiber composite and a metallic material, wherein the striking plate has a combination portion formed as a back side of the striking plate;
putting a plurality of carbon fiber composite prepregs that are piled up and the striking plate into the mold assembly and closing the mold assembly to form a blank of a golf club head, wherein the carbon fiber composite prepregs are piled up to form a blank of a head body of the golf club head which has a main portion and a hosel, and a front end of the blank of the head body of the golf club head engages with the combination portion of the striking plate to form the blank of the golf club head;
applying vacuum to the mold assembly and heating the mold assembly with the blank of the golf club head inside by using the pressure forming device, wherein the mold assembly with the: blank of the golf club head inside is put in a bag and the bag is put into the openable closed container for the pneumatic assembly to create the vacuum in the operable closed container and for the heating assembly to heat the blank of the golf club head, such that the carbon fiber composite prepregs of the blank of the golf club head are hardened by a cross-linking reaction to form a semi-finished golf club head; and
debarring the semi-finished golf club head and finishing a surface of the semi-finished golf club head to form the composite golf club head.

2. The method as claimed in claim 1, wherein in the step of applying vacuum to the mold assembly and heating the old assembly with the blank of the golf club head inside by using a pressure forming device, a heating temperature ranges from 40° C. to 250° C., vacuum pressure value ranges from −0.1 mbar to −1000 mbar, and the heating and the vacuuming lasts for 1 minute to 60 minutes.

3. The method as claimed in claim 1, wherein in the step of applying vacuum to the mold assembly and heating the mold assembly with the blank of the golf club head inside by using a pressure forming device, a heating temperature ranges from 40° C. to 250° C., and vacuum pressure value ranges from −0.1 mbar to −1000 mbar, the heating and the vacuuming lasts for 1 minute to 60 minutes and the pressure forming device inputs positive air pressure to the blank of the golf club head, wherein an air pressure value of the input positive air pressure ranges from 2 bar to 100 bar.

4. The method as claimed in claim 1, wherein in the step of putting the carbon fiber composite prepregs that are piled up and the striking plate into the mold assembly and closing the mold assembly to form the blank of the golf club head, a replaceable rod is inserted in the hosel.

5. The method as claimed in claim 2, wherein in the step of putting the carbon fiber composite prepregs that are piled up and the striking plate into the mold assembly and closing the mold assembly to form the blank of the golf club head, a replaceable rod is inserted in the hosel.

6. The method as claimed in claim 3, wherein in the step of putting the carbon fiber composite prepregs that are piled up and the striking plate into the mold assembly and closing the mold assembly to form the blank of the golf club head, a replaceable rod is inserted in the hosel.

7. The method as claimed in claim 1, wherein in the step of putting the carbon fiber composite prepregs that are piled up and the striking plate into the mold assembly and closing the mold assembly to form the blank of the golf club head, a metal counterweight is put in the blank of the golf club head and the metal counterweight is attached to or wrapped by the carbon fiber composite prepregs.

8. The method as claimed in claim 2, wherein in the step of putting the carbon fiber composite prepregs that are piled up and the striking plate into the mold assembly and closing the mold assembly to form the blank of the golf club head, a metal counterweight is put in the blank of the golf club head and the metal counterweight is attached to or wrapped by the carbon fiber composite prepregs.

9. The method as claimed in claim 3, wherein in the step of putting the carbon fiber composite prepregs that are piled up and the striking plate into the mold assembly and closing the mold assembly to form the blank of the golf club head, a metal counterweight is put in the blank of the golf club head and the metal counterweight is attached to or wrapped by the carbon fiber composite prepregs.

10. A composite golf club head which is manufactured by the method as claimed in claim 1 and has a center of gravity, the composite golf club head comprising:
a head body having
a main portion made of a carbon fiber composite and integrally formed as a single part; and
a hosel formed on a front end of the main portion; and
a striking plate mounted on the head body and made of a material selected from the group consisting of a carbon fiber composite and a metallic material, the striking plate attached to the front end of the main portion and having
a combination portion which is formed as a back side of the striking plate and attached to the main portion; and
a geometric center point;
wherein an imaginary line passing through the geometric center point and the center of gravity of the composite golf club head is perpendicular to a tangent plane of the geometric center point.

11. The composite golf club head as claimed in claim 10, wherein the striking plate has a sweet point, an imaginary line passing through the sweet point and the center of the gravity of the composite golf club head is perpendicular to a tangent plane of the sweet point, and the sweet point overlaps the geometric center point.

12. The composite golf club head as claimed in claim 10, wherein the head body has
at least one metal counterweight fixed to a bottom of the main portion; and
a replaceable rod inserted inside the hosel.

13. A composite golf club head which is manufactured by the method as claimed in claim 2 and has a center of gravity, the composite golf club head comprising:
a head body having
a main portion made of a carbon fiber composite and integrally formed as a single part; and
a hosel formed on a front end of the main portion; and
a striking plate mounted on the head body and made of a material selected from the group consisting of a carbon fiber composite and a metallic material, the striking plate attached to the front end of the main portion and having
a combination portion which is formed as a back side of the striking plate and attached to the main portion; and
a geometric center point;
wherein an imaginary line passing through the geometric center point and the center of gravity of the composite golf club head is perpendicular to a tangent plane of the geometric center point.

14. The composite golf club head as claimed in claim 13, wherein the striking plate has a sweet point, an imaginary line passing through the sweet point and the center of the gravity of the composite golf club head is perpendicular to a tangent plane of the sweet point, and the sweet point overlaps the geometric center point.

15. The composite golf club head as claimed in claim 13, wherein the head body has
at least one metal counterweight fixed to a bottom of the main portion; and
a replaceable rod inserted inside the hosel.

16. A composite golf club head which is manufactured by the method as claimed in claim 3 and has a center of gravity, the composite golf club head comprising:
a head body having
a main portion made of a carbon fiber composite and integrally formed as a single part; and
a hosel formed on a front end of the main portion; and
a striking plate mounted on the head body and made of a material selected from the group consisting of a carbon fiber composite and a metallic material, the striking plate attached to the front end of the main portion and having
a combination portion which is formed as a back side of the striking plate and attached to the main portion; and
a geometric center point;
wherein an imaginary line passing through the geometric center point and the center of gravity of the composite golf club head is perpendicular to a tangent plane of the geometric center point.

17. The composite golf club head as claimed in claim 15, wherein the striking plate has a sweet point, an imaginary line passing through the sweet point and the center of the gravity of the composite golf club head is perpendicular to a tangent plane of the sweet point, and the sweet point overlaps the geometric center point.

18. The composite golf club head as claimed in claim 15, wherein the head body has
at least one metal counterweight fixed to a bottom of the main portion; and
a replaceable rod inserted inside the hosel.
